(19) United States
(12) Patent Application Publication
(10) Pub. No.: US 2012/0111650 A1
(43) Pub. Date: May 10, 2012

(54) Drive System

(75) Inventor: Michael Czysz, Portland, OR (US)

(73) Assignees: MOTOCZYSZ, Portland, OR (US); REMY TECHNOLOGIES, L.L.C., Pendleton, IN (US)

(21) Appl. No.: 13/289,647

(22) Filed: Nov. 4, 2011

Related U.S. Application Data
(60) Provisional application No. 61/410,283, filed on Nov. 4, 2010.

(51) Int. Cl. B60K 1/00; H02K 9/19; H02K 5/18; H02K 5/22

(52) U.S. Cl. 180/65.1; 310/71; 310/54

(57) ABSTRACT

A drive system package includes a housing. Located at the housing are a mechanical interface to output mechanical power, an electrical power connector receiver and a user interface. A motor vehicle includes a motor vehicle frame and one or more drive components. The motor vehicle further includes a drive system package having a housing. A mechanical interface is located at the housing and is operably connectable to the one or more drive components. The drive system package further includes an electrical power connector receiver and a user interface located at the housing.

### CROSS-REFERENCE TO RELATED APPLICATION

This application claims priority to U.S. provisional application, 61/410,283, filed Nov. 4, 2010, the entire contents of which are incorporated herein by reference.

### BACKGROUND

Much attention has recently been focused upon alternate energy sources and motive configurations. Some of that focus is on vehicular configurations. Electric vehicles and hybrid vehicles are enjoying increasing popularity in an age of public responsibility for global stewardship. Adjunct to this move in development is that smaller and lighter is better since more of the energy available is used for range rather than torque.

### SUMMARY

A drive system package includes a housing. Located at the housing are a mechanical interface to output mechanical power, an electrical power connector receiver and a user interface.

A motor vehicle includes a motor vehicle frame and one or more drive components. The motor vehicle further includes a drive system package having a housing. A mechanical interface is located at the housing and is operably connectable to the one or more drive components. The drive system package further includes an electrical power connector receiver and a user interface located at the housing.

### BRIEF DESCRIPTION OF THE DRAWINGS

Referring now to the drawings wherein like elements are numbered alike in the several Figures:

FIG. 1 is perspective view of an embodiment of a drive system package;

FIG. 2 is another perspective view of an embodiment of a drive system package;

FIG. 3 is a side view of an embodiment of a drive system package;

FIG. 4 is another side view of an embodiment of a drive system package;

FIG. 5 is yet another side view of an embodiment of a drive system package;

FIG. 6 is still another side view of an embodiment of a drive system package;

FIG. 7 is another side view of an embodiment of a drive system package; and

FIG. 8 is yet another side view of an embodiment of a drive system package.

### DETAILED DESCRIPTION

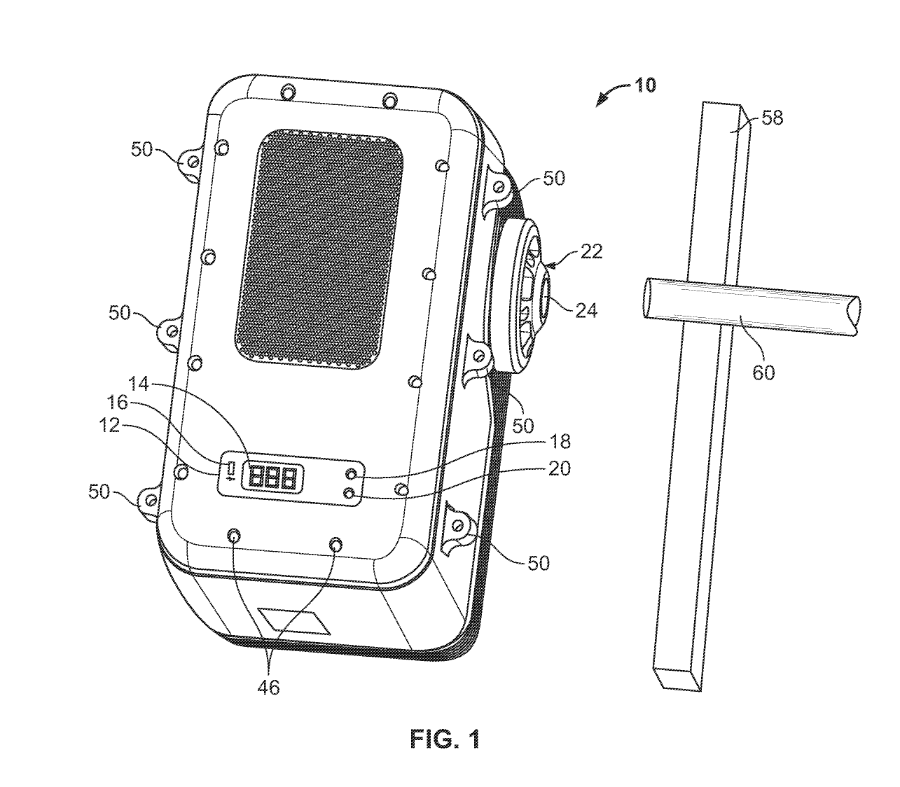

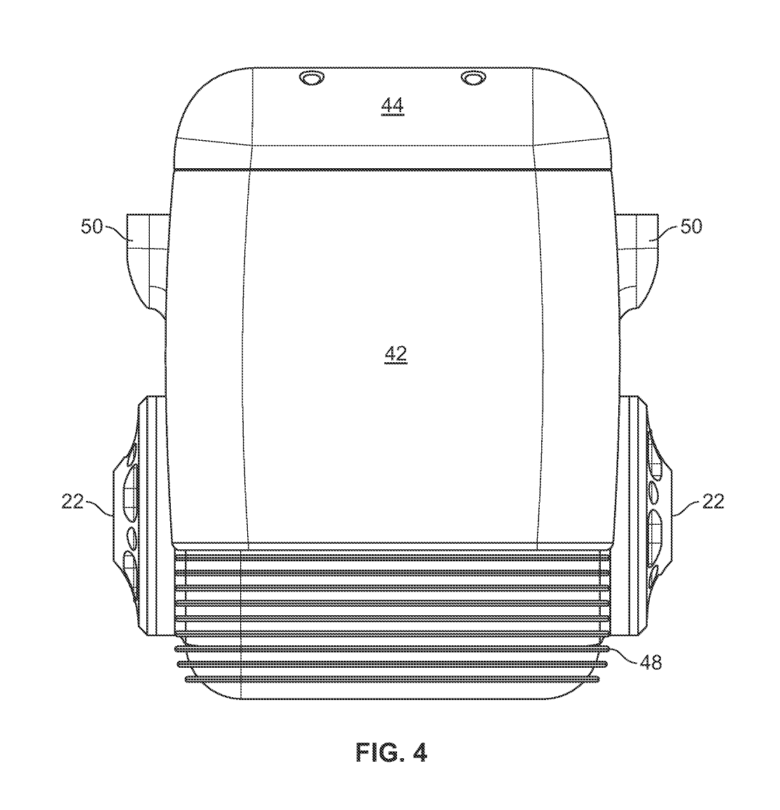

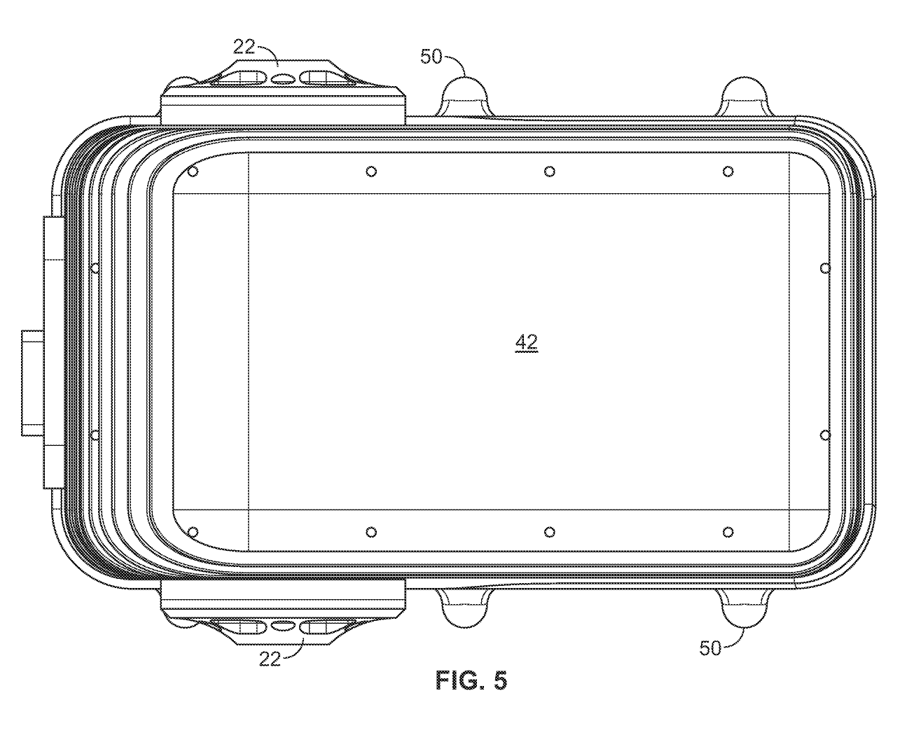

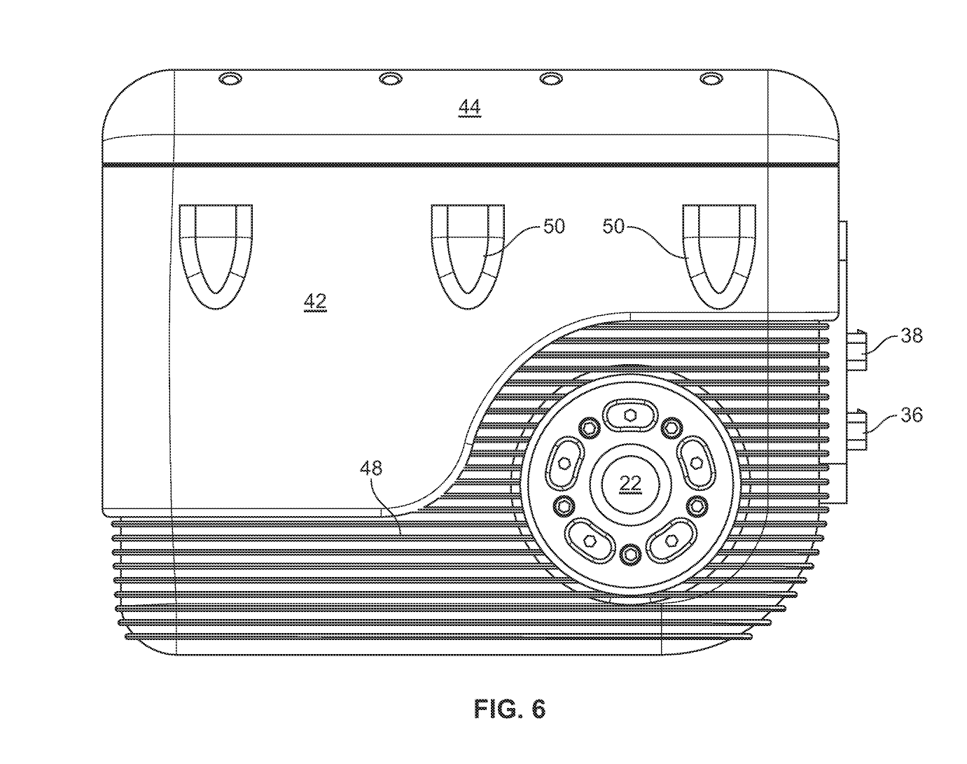

Illustrated in FIGS. 1-8 is a fully integrated package 10 having a number of interfaces and containing a number of individual elements enabling the package 10 to provide motion to a vehicle (or any other construction needing a motion provider). Referring to FIG. 1, the interfaces include a user interface 12 comprising, for example, a display 14, which in some embodiments is a touchpad, one or more USB ports 16, a power LED 18 and a system LED 20 as illustrated. It is to be appreciated that the user interface 12 may include more or fewer elements or different elements and still be considered within the context of this disclosure. The user interface 12 may be used for data input or data output either directly at the user interface 12 or through the use of another device (such as a laptop computer, PDA, iPad, etc.) operatively connected to the interface 12 through the USB port 16 or other, including wireless, connection. The user interface 12 further facilitates parameter monitoring and operating parameter adjustment allowing the user to optimize performance characteristics for a particular application.

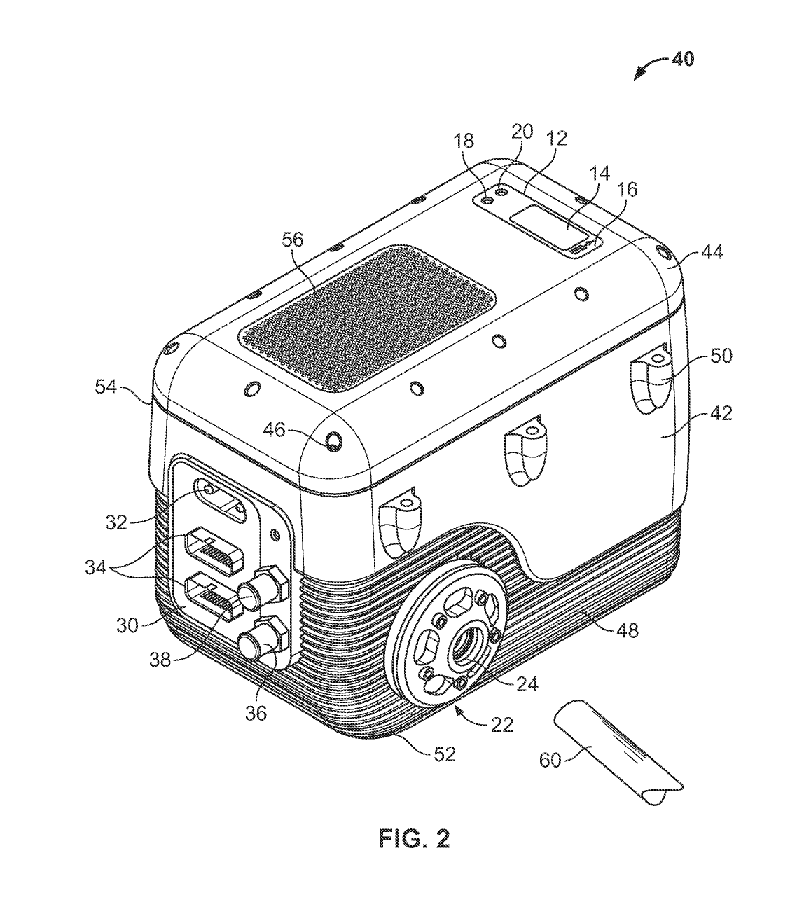

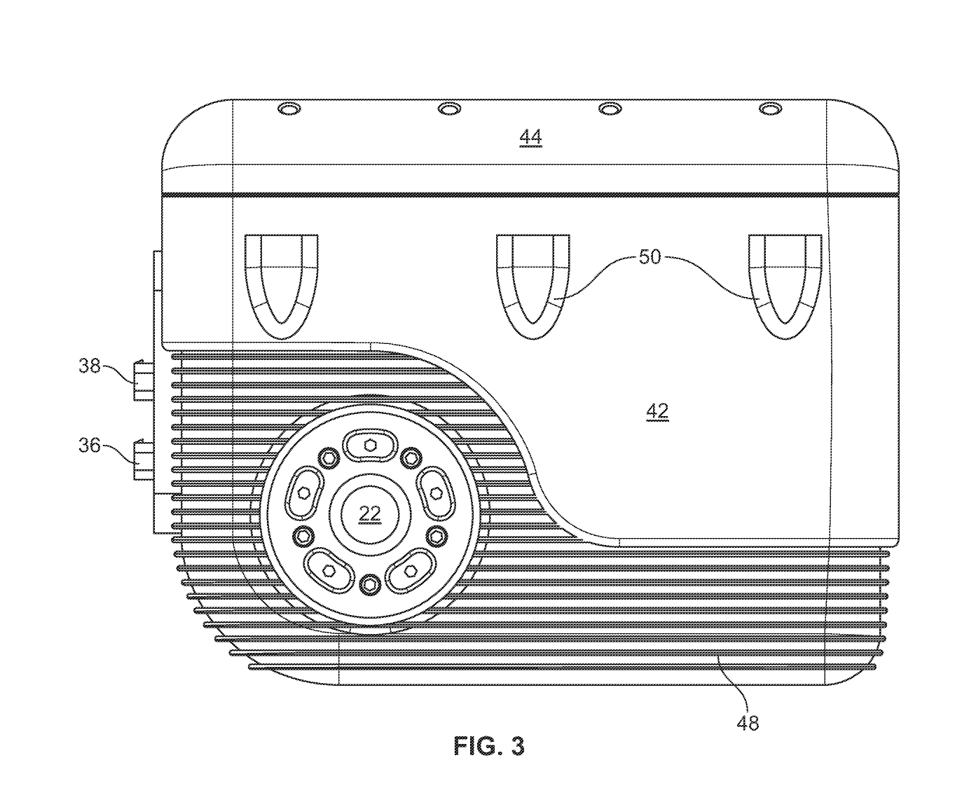

Referring now to FIG. 2, a mechanical interface 22 is positioned at at least one side of the package 10 and may be at both sides (as shown in FIGS. 3-6) and axially aligned. Alternatively, the mechanical interface 22 at a first side 52 may be axially misaligned from the mechanical interface 22 at a second side 54. Further, while the mechanical interfaces 22 are shown at opposing sides 52 and 54, mechanical interfaces 22 may be located at non-opposing sides. The mechanical interface 22 is intended and is configured to provide for a mechanical connection to a portion of a drive system of a target construction, for example, a motor vehicle. In the illustrated embodiment the interface 22 includes a female spline at 24 that will receive a complementary male spline of a half shaft, for example, or other drive component 60. The interface 22 is also changeable to support use of the package 10 with different drive systems such as vehicles from various manufacturers. Seals for the interface are also accessible by disassembling the interface.

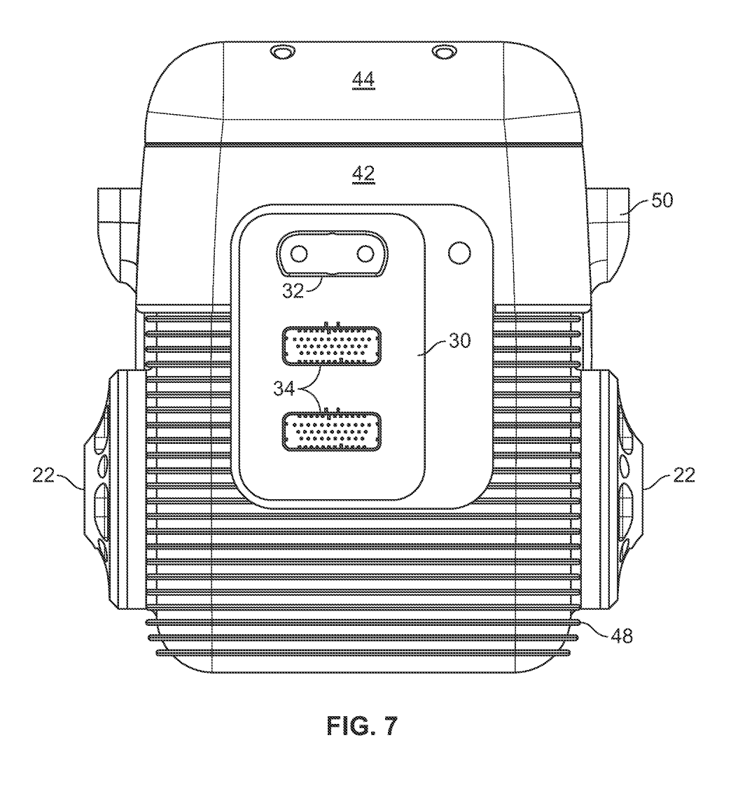

Referring now to FIG. 7, the package 10 includes a functional interface 30 comprising, for example, an electrical power connector receiver 32, one or more low voltage connector receivers 34, and referring again to FIG. 2, a coolant inlet 36 and a coolant outlet 38. It is to be understood that although the elements of the functional interface 30 are illustrated as discussed, more or fewer or other interface elements may be substituted without departing from the concepts disclosed herein.

Each of the interfaces is disposed at a surface of a housing 40 comprising in one embodiment, a base 42 and a cover 44. The cover and base together define a cavity therewithin that contains a motor and a motor controller. Other components, such as a differential, gear reduction, bearings, oil pump and/or heat exchanger may also be present in the cavity. It is also to be understood that in some embodiments, the cavity within housing 40 contains an inverter. The components are packaged within the housing 40 such that the cover 44 if removed will provide easy access to the motor controller for repair or replacement of parts in need of attention. These components include those listed above and optionally internal fusing systems, breaker systems, etc. It is to be understood however that these systems can also be external to the package. It is to be understood that although the illustrations use bolts 46 to secure the cover 44 to the base 42, other means for attachment such as latches and clips, for example could be substituted or added.

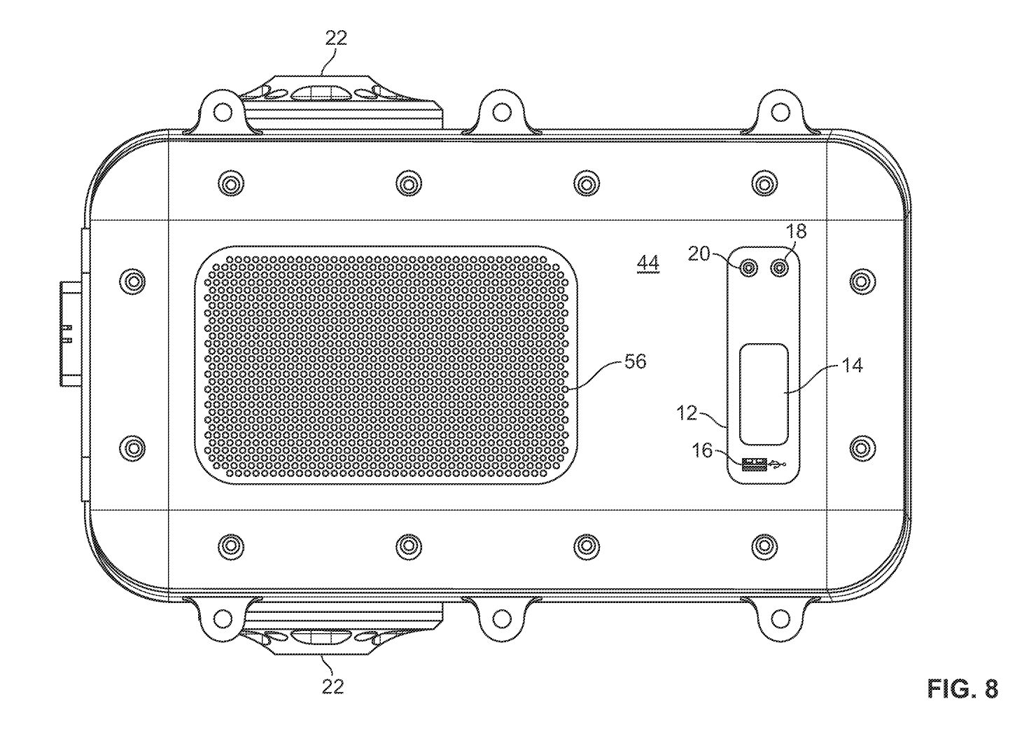

In one embodiment the heat exchanger (not visible inside the housing 40) is fluidly connected to an external fluid source through inlet 36 and outlet 38 at interface 30. Through the interface, cooling fluid is flowed to remove heat from the system. Additional radiative cooling is achieved in some embodiments through lubrication fluids and cooling fins 48 extending around the base 42. Further cooling may be provided by a screen 56 in the cover 44 as shown in FIG. 8.

Referring again to FIG. 1, the base 42 includes a number of bosses 50 provided to mount the package 10 to a vehicular or other frame 58.

While one or more embodiments have been shown and described, modifications and substitutions may be made thereto without departing from the spirit and scope of the invention. Accordingly, it is to be understood that the present invention has been described by way of illustrations and not limitation.

1. A drive system package comprising:
a housing;
a mechanical interface to output mechanical power disposed at the housing;
an electrical power connector receiver disposed at the housing; and
a user interface disposed at the housing.

2. The drive system package of claim 1, wherein the user interface comprises one or more of a display, a USB port and an LED.

3. The drive system package of claim 2, wherein the display comprises a touch pad.

4. The drive system package of claim 1, wherein the housing is receptive of one or more of a motor, motor controller, differential, gear reduction, bearings, oil pump and heat exchanger.

5. The drive system package of claim 1, wherein the mechanical interface comprises a spline connection.

6. The drive system package of claim 1, wherein the mechanical interface is changeable.

7. The drive system package of claim 1, further comprising two or more mechanical interfaces.

8. The drive system package of claim 7, wherein two mechanical interfaces of the two or more mechanical interfaces are axially aligned.

9. The drive system package of claim 1, further comprising coolant inlet and a coolant outlet for circulation of a coolant through the drive system package.

10. The drive system package of claim 1, further comprising one or more low voltage connector receivers.

11. The drive system package of claim 1, wherein the housing includes a plurality of cooling fins extending from an exterior thereof.

12. The drive system package of claim 1, further comprising a cooling screen disposed in the housing.

13. The drive system package of claim 1, wherein the housing includes a plurality of mounting bosses to mount the drive system package to a vehicular or other frame.

14. A motor vehicle comprising:
a motor vehicle frame;
one or more drive components; and
a drive system package including:
a housing;
a mechanical interface disposed at the housing operably connectable to the one or more drive components;
an electrical power connector receiver disposed at the housing; and
a user interface disposed at the housing.

15. The motor vehicle of claim 14, wherein the user interface comprises one or more of a display, a USB port and an LED.

16. The motor vehicle of claim 14, wherein the housing is receptive of one or more of a motor, motor controller, differential, gear reduction, bearings, oil pump and heat exchanger.

17. The motor vehicle of claim 14, wherein the mechanical interface comprises a spline connection.

18. The motor vehicle of claim 14, further comprising coolant inlet and a coolant outlet for circulation of a coolant through the drive system package.

19. The motor vehicle of claim 14, wherein the housing includes a plurality of cooling fins extending from an exterior thereof.

20. The motor vehicle of claim 14, further comprising a cooling screen disposed in the housing.
